(19) United States
(12) Patent Application Publication
(10) Pub. No.: US 2009/0051761 A1
(43) Pub. Date: Feb. 26, 2009

(54) DISPLAY SYSTEM, DISPLAY DEVICE, DISPLAY METHOD, PROGRAM AND MEMORY MEDIA

(76) Inventor: Takashi Atarashi, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/281,532

(22) PCT Filed: Nov. 10, 2006
(86) PCT No.: PCT/JP2006/322466

§ 371 Date: Sep. 3, 2008

(30) Foreign Application Priority Data
Mar. 14, 2006 (JP) 2006-069976

(51) Int. Cl. H04N 13/04

(52) U.S. Cl. 348/54

(57) ABSTRACT

A TV (1) provided with a display device (2) for displaying information in a plurality of different display directions is controlled by an operation signal transmitted from a remote controller (12). The television (1) is provided with display device-side sensor s (8aL/R, 8bL/R) arranged to correspond to the display directions, respectively; and a display device controller (5) for controlling the display means to display information in accordance with an operation signal in the display direction corresponding to the display device-side sensors with received the operation signal.

### TECHNICAL FIELD

The present invention relates to a display device which is capable of displaying different information in different directions and a display system including the display device.

### BACKGROUND ART

In recent years, a flat-panel display has been grown in size and a dual view display device which is capable of displaying two different information including a still image and a moving image in the right direction and in the left direction has been proposed. In the case where a viewer in the left side watches information displayed in the left side of the dual-view display and a viewer in the right side watches information displayed in the right side of the dual-view display, the viewers in either direction should act as follows, if they want to change the watching information respectively at the same time: one viewer changes the information with use of a remote controller and passes the remote controller to the other viewer, and then the other viewer changes the information in a viewing direction with the received remote controller.

To improve this situation, a display device 100 of patent document 1 and patent document 2 illustrated in FIG. 8 includes a display section 101 which is capable of performing dual view display, a remote controller 102 for controlling information displayed on the display section 101 in a viewing direction, and a display device-side sensor 103 for detecting a direction of an infrared ray transmitted from the remote controller 102.

When a viewer in the left side changes information displayed on the display section 101 in the left display direction, the viewer operates the remote controller 102 toward the left side of the display section 101. Then, the display device-side sensor 103, which is provided at a center top of the display device 100, detects a direction of the remote controller 102 operated by the viewer and an infrared image selection signal for changing display information transmitted from the remote controller 102. A display device controller 104 receives the detected display direction and the image selection signal, and then changes the information displayed in the requested direction according to the image selection signal. The display device 100 with this structure allows changing information displayed only in a direction where the viewer operates the remote controller among a plurality of different display directions.

Similarly, a viewer in the right side changes information displayed on the display section 101 in the right display direction, the viewer operates a remote controller 105 toward the right side of the display section 101. Then, the display device-side sensor 103 detects a direction of the remote controller 105 operated by the viewer and an infrared image selection signal for changing information transmitted from the remote controller 105. The display device controller 104 receives the detected display direction and the image selection signal, and then changes the information displayed in the requested display direction. The display device 100 with this structure allows changing information displayed only in a direction where the viewer operates the remote controller among a plurality of different display directions.

Patent Document 1: Japanese Unexamined Patent Publication, Tokukaihei 11-331876 (date of publication Nov. 30, 1999)

Patent Document 2: Japanese Unexamined Patent Publication, Tokukai 2005-73076 (date of publication Mar. 17, 2005)

### DISCLOSURE OF INVENTION

With a conventional technique, after a display device detects a direction of a remote controller, only information displayed in the detected direction allows to be changed. Therefore, when a plurality of viewers watch the display device displaying different information in different directions, information displayed in a direction where a viewer operates the remote controller is only allowed to change. Therefore, in the case where a plurality of viewers watch different information, each of the viewers needs to have each individual remote controller so that each of the viewers changes each of the information displayed in each of the display directions freely by using each individual remote controller. There is a possibility that a plurality of viewers in different directions cannot conveniently control the display device, respectively.

The present invention is made in view of the forgoing problem and an object of the present invention is to provide a display device, which allows a viewer to control information displayed in a desired display direction regardless of where the viewer is, and a display system including the display device.

To attain the object, a display device of the present invention includes display means which is capable of displaying information in different display directions; a plurality of operation signal receiving means provided respectively corresponding to the different display directions, and each configured to receive an operation signal; and display control means configured to control the display means to display information according to the operation signal in the direction corresponding to that one of the operation signal receiving means which received the operation signal.

Further, to attain the object, a method of displaying information on a display device which is capable of displaying information in different display directions, including: providing the display device including operation signal receiving means respectively corresponding to the different display directions; receiving an operation signal by any one of operation signal receiving means; and displaying information according to the operation signal in the display direction corresponding to that one of the operation signal receiving means which received the operation signal.

With these arrangements, information displayed by the display device in a certain display direction corresponds to an operation signal received by an operation signal receiving means corresponding to the certain direction. Therefore, for example, in order to control information in a first display direction, an operation signal should be received by an operation signal receiving means corresponding to the first display direction; in order to control information in a second display direction, an operation signal should be received by an operation signal receiving means corresponding to the second display direction.

Therefore, for example, it is possible to allow a viewer to control information displayed in a desired direction regardless of the viewer's position by using an operation device configured to transmit a directional carrier wave to any one of the plurality of the operation signal receiving means. Namely, for example, a viewer in the first direction viewed from the display device can control information displayed in the second display direction; on the contrary, a viewer in the second direction viewed from the display device can control information displayed in the first display direction.

Note that the above display device and a display system including the display device are also included within the scope of the present invention.

Namely, to attain the object, a display system of the present invention includes a display device and an operation device configured to transmit an operation signal to the display device, wherein the display device includes: display means which is capable of displaying information in a plurality of different display directions, a plurality of operation signal receiving means configured to receive an operation signal which are provided corresponding to the plurality of different display directions, and display control means which controls the display means to display information according to the operation signal in a direction corresponding to any one of the operation signal receiving means which received the operation signal; the operation device includes: operation signal transmission means configured to transmit the operation signal on a directional carrier wave to any one of the operation signal receiving means.

It is preferable that the operation signal receiving means are respectively provided in an edge part of the display device in such a manner that the operation signal receiving means is provided at that portion of the edge part which is on the display direction that the operation signal receiving means corresponds.

With this arrangement, a plurality of operation signal receiving means corresponding to different display directions are arranged leaving distance with each other. For example, in the case where the display means displays information in the right display direction and in the left display direction, an operation signal receiving means corresponding to the right display direction is arranged in the right edge part of the display device and an operation signal receiving means corresponding to the left display direction is arranged in the left edge part of the display device.

Therefore, the operation device for transmitting the operation signal to the display device can surely specify which operation signal receiving means to receive the operation signal. As a result, a user who controls the display device via the operation device can surly control information displayed in a desired display direction.

It is preferable that the operation signal receiving means is arranged on a line overlapping a diagonal line of the display means.

According to this arrangement, the operation signal receiving means are arranged leaving a farther distance with each other. For example, in the case where the display means displays information in the right display direction and in the left display direction, an operation signal receiving means corresponding to the right display direction is arranged at the upper right edge part of the display device and the other operation signal receiving means corresponding to the left display direction is arranged at lower left edge part of the display device. (The former may be arranged at lower right edge part and the latter may be arranged at upper left edge part.)

Therefore, the operation device for transmitting the operation signal to the display device can surely specify which operation signal receiving means to receive the operation signal. As a result, a user who controls the display device via the operation device can surly control the display information in a desired display direction.

It is preferable that the display device of the present invention further includes discrimination signal transmission means configured to transmit discrimination signals having different characteristics to the different display directions, wherein the operation signal receiving means receives an operation signal, (i) which is transmitted from the operation device which received the discrimination signal, and (ii) which corresponds to the direction where the operation device is located.

With this arrangement, the operation device which received the discrimination signal identifies its display direction with regard to the display device by using the discrimination signal. This allows the operation device to transmit the operation signal corresponding to the display direction where it is located. Namely, the display device can receive the operation signal corresponding to the display direction where the operation device is located. As a result, it is possible to have another advantage that the display device can control information displayed on the display means corresponding to the direction where the operation device is located.

It is preferable that the display device of the present invention further includes display condition detection means configured to detect a display condition of the display means, wherein the display control means is configured to display information indicating the display condition of the display means according to a detection result of the display condition detection means.

With this arrangement, information indicating a display condition of the display means is displayed on the display means. The display means displays information in a plurality of directions. For example, in the case where display information in the first display direction is not displayed, information indicating this display abnormality can be displayed in the second display direction. Therefore, for example, viewers can deal with the display abnormality based on the information of the display abnormality displayed on the display means.

Further, the display device may be realized by using a computer. In this case, a program configured to operate the computer as the display device, and a computer-readable recording medium which stores the program therein are also included in the scope of the present invention by operating the computer as each of the means.

### BRIEF DESCRIPTION OF DRAWINGS

FIG. 1 is a block diagram of a display system of the present invention.

FIG. 2 is a block diagram of a remote controller of the present invention.

FIG. 3 is a block diagram of a remote controlling system of the present invention.

FIG. 4 is a flow chart of an output signal from a remote controller of the present invention.

FIG. 5 is a flow chart of display control in a TV of the present invention.

FIG. 6 is a flow chart of display operation of condition information of the present invention.

FIG. 7 is a flow chart of information display of a TV of the present invention.

FIG. 8 is a block diagram of a conventional TV display system.

### EXPLANATION OF REFERENCE NUMERALS

1 TV (display device)
2 display device (display means)
3a light receiving device (display condition detection means)
3b light receiving device (display condition detection means)
4 determination device
5 display device controller (display control means)
6 recording media
7a channel selection information generator
7b channel selection information generator
8aL first left direction signal detecting display device-side sensor (operation signal receiving means)
8aR first right direction signal detecting display device-side sensor (operation signal receiving means)
8bL second left direction signal detecting display device-side sensor (operation signal receiving means)
8bR second right direction signal detecting display device-side sensor (operation signal receiving means)
9 discrimination signal generator
10L left direction display device-side transmitter
10R right direction display device-side transmitter
11 LCD interface
12 remote controller (operation device)
13 remote controller-side transmitter (operation signal transmission means)
14 remote controller controlling device
15 remote controller-side sensor

### BEST MODE FOR CARRYING OUT THE INVENTION

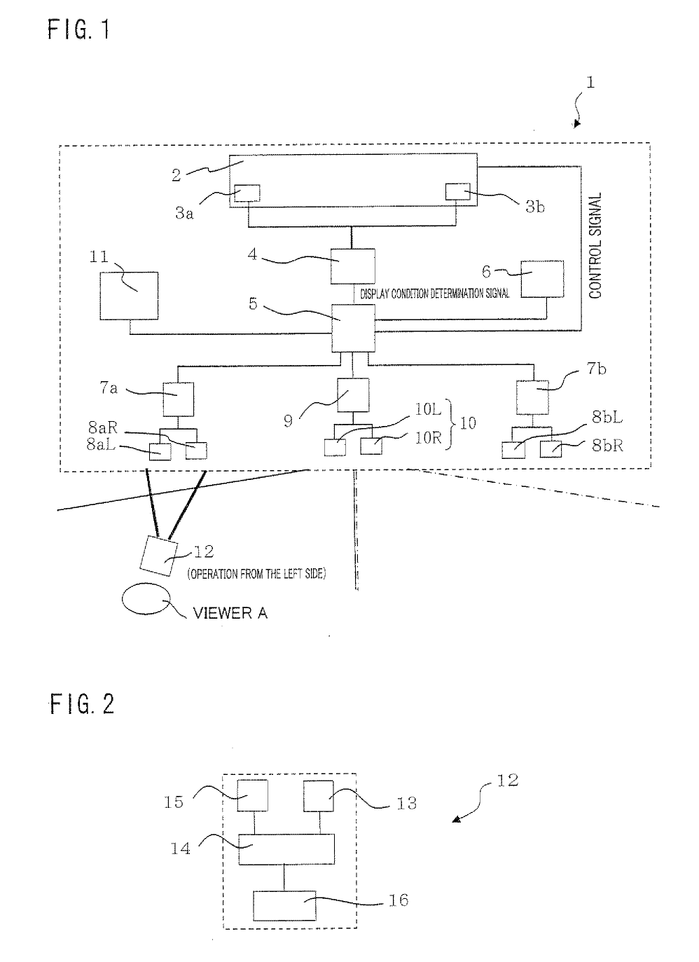

One embodiment of the display system of the present invention is described below with reference to FIG. 1 though FIG. 7. FIG. 1 is a block diagram of a TV display system including the display system. As illustrated in FIG. 1, the TV display system includes a TV 1, and a remote controller 12. The following explanation deals with a function of respective sections in the TV 1 and the remote controller 12.

The TV 1 includes a display device 2, a light receiving device 3a, a light receiving device 3b, a determination device 4, a display device controller 5, a recording medium 6, a channel selection information generator 7a, a channel selection information generator 7b, a first left direction signal detecting display device-side sensor 8aL, a first right direction signal detecting display device-side sensor 8aR, a second left direction signal detecting display device-side sensor 8bL, a second right direction signal detecting display side sensor 8bR, a discrimination signal generator 9, a left direction display device-side transmitter 10L, a right direction display device-side transmitter 10R, and a display device interface 1. The remote controller 12 includes a remote controller-side transmitter 13, a remote controller controlling device 14, a remote controller-side sensor 15, and a remote controller interface 16.

The display device 2 is capable of displaying a single view display and a multi view display which displays information in different directions simultaneously and includes a back light, a liquid crystal display, and a barrier layer. The barrier layer, the liquid crystal display, and the back light are arranged in this order from the front. Also, the display device 2 is connected with a back light control circuit for controlling the back light of the display device 2 and is also connected with a power supply circuit for receiving a power supply voltage from the power supply circuit. Further, the display device controller 5, which controls the display device 2 to display an image of a channel selected by a viewer, is also connected to the display device 2. This allows the display device 2 to display an image based on a supplied display signal.

The barrier layer has a plurality of vertical translucency slits and a plurality of opaque region arranged alternatively. For example, a light emitted from the back light passing through pixels in odd number columns is projected in the left direction via the plurality of translucency slits, and a light emitted from the back light passing through pixels in even number columns is projected in the right direction via the plurality of translucency slits. Accordingly, an image in the left display direction can be seen from a viewer in the left side of the display device 2, and an image in the right display direction can be seen from a viewer in the right side of the display device 2. As a display device 2 which is capable of performing the multi view display, a case of using the barrier layer was explained. However, other methods such as a lens method or a field sequential method are also applicable.

Further, the display device 2 has two different multi view display modes, one display mode is for displaying only in the left direction and the other display mode is for displaying only in the right direction. When the display mode for displaying only in the left direction is selected, pixels in even number columns are not in operation and only the pixels in odd number columns are in operation. This allows only the light emitted from the back light passing through the pixels in the odd number columns is projected via the plurality of translucency slits. Similarly, when the display mode for displaying only in the right direction is selected, the pixels in the odd number columns are not in operation and only the pixels in the even number columns are in operation. This allows only light emitted from the back light passing through the pixels in the even number columns is projected via the plurality of translucency slits.

This allows selecting the display mode for displaying only in the left direction when a viewer exists only in the left side, and selecting the display mode for displaying only in the right direction when a viewer exists only in the right side as each multi view display mode. In this case, the pixels in operation are half in number, which can realize low power consumption.

The light receiving device 3a and the light receiving device 3b detect light from the display device 2 and output a detection result. It is possible to adopt devices which have a function of receiving light such as a CCD and a CMOS image sensor as the light receiving device 3a and the light receiving device 3b provided in the display device 2 for detecting light. In this specification, light receiving sensors are provided on the right side and the left side of the display device 2, however, the number of light receiving devices and the positions are not limited to this.

The determination device 4 is connected with the light receiving device 3a and the light receiving device 3b for receiving emission light detection results from them. The determination device 4 generates a discrimination signal based on the received emission light detection results and provides the discrimination signal to the display device controller 5.

The display device interface 11 is an interface which involves at least one of a touch panel, an operation key, and voice, and is used for conducting various operations such as a channel selection of the display device 2, a volume control, and a power ON/OFF control. The display device interface 11 is connected to the display device controller 5 to control the display device 2 based on an operation of the display device interface 11

The recording medium 6 recodes and stores image data temporarily. The recording medium 6 is used in the process of image processing operation and is connected with the display device controller 5.

The discrimination signal generator 9 is connected with an output of the display device controller 5. An output of the discrimination signal generator 9 is connected with the left direction display device-side transmitter 10L and the right direction display device-side transmitter 10R. When the TV1 is in the single view display mode, a first control signal corresponding to this mode is provided from the display device controller 5 to the discrimination signal generator 9. When the TV 1 is in the multi view display mode, a second control signal corresponding to this mode is provided from the display device controller 5 to the discrimination signal generator 9. On receiving the first control signal, the discrimination signal generator 9 controls the left direction display device-side transmitter 10L and the right direction display device-side transmitter 10R to output a first discrimination signal having the same characteristic in every direction. On receiving the second control signal, the discrimination signal generator 9 controls the left direction display device-side transmitter 10L to output a second discrimination signal 1 and the right direction display device-side transmitter 10R to output a second discrimination signal 2, alternatively at certain intervals. The second discrimination signal 1 and the second discrimination signal 2 are signals have at least one different characteristic, such as amplitude and frequency. The second discrimination signal 1 is released in the left direction and the second discrimination signal 2 is released in the right direction.

The channel selection information generator 7a is connected with the first left direction signal detecting display device-side sensor 8aL and the first right direction signal detecting display device-side sensor 8aR. The first left direction signal detecting display device-side sensor 8aL and the first right direction signal detecting display device-side sensor 8aR detect an operation signal from the remote controller 12 and provide a detection result to the channel selection information generator 7a. The channel selection information generator 7a is further connected with the display device controller 5. According to the detection result, the channel selection information generator 7a generates a display control signal corresponding to a display mode of the TV 1. Then, the channel selection information generator 7a provides the display control signal to the display device controller 5. The display device controller 5 controls the TV 1 in channel selection and volume control according to the display control signal.

The channel selection information generator 7b is connected with the second left direction signal detecting display device-side sensor 8bL and the second right direction signal detecting display device-side sensor 8bR. The second left direction signal detecting display device-side sensor 8bL and the second right direction signal detecting display device-side sensor 8bR detect an operation signal from the remote controller 12 and provide a detection result to the channel selection information generator 7b. The channel selection information generator 7b is further connected with the display device controller 5. According to the detection result, the channel selection information generator 7b generates a display control signal corresponding to a display mode of the TV 1. Then, the channel selection information generator 7b provides the display control signal to the display device controller 5. The display controller 5 controls the TV 1 in channel selection and volume control according to the display control signal.

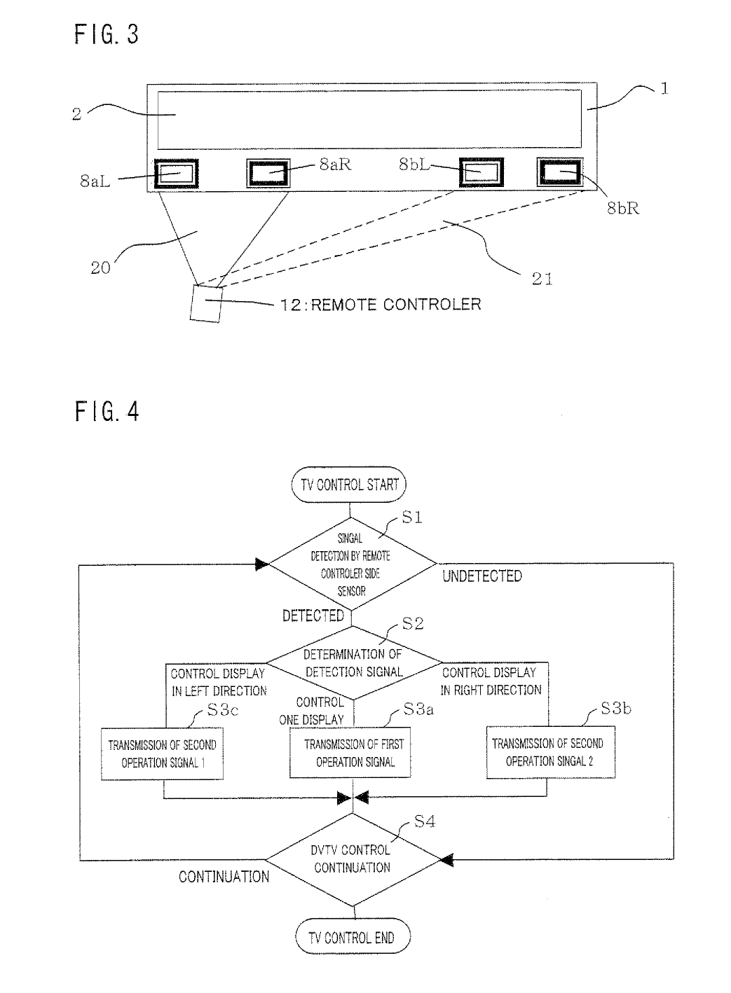

As illustrated in FIG. 3, one example structure is shown such that a left direction display device-side sensor including the first left direction signal detecting display device-side sensor 8aL and the first right direction signal detecting display device-side sensor 8aR is provided in the left side part of the TV 1 and a right direction display device-side sensor including the second left direction signal detecting display device-side sensor 8aL and the second right direction signal detecting display device-side sensor 8aR is provided in the right side part of the TV 1. Since these sensors are located on both sides of the TV 1, respectively, it is possible for the remote controller 12 to output an operation signal only to a certain display device-side sensor. This makes easy to change information provided from the TV 1.

The first left direction signal detecting display device-side sensor 8aL and the first right direction signal detecting display device-side sensor 8aR may be provided in lower left edge part of the TV 1 and the second left direction signal detecting display device-side sensor 8aL and the second right direction signal detecting display device-side sensor 8aR may be provided in upper right edge part of the TV 1. In this case, the left direction display device-side sensor and the right direction display device-side sensor become farther in distance. This allows preventing receipt of a wrong signal and makes easier to change information provided from the TV 1. The left direction display device-side sensor and the right direction display device-side sensor are not limited to the above positions.

As illustrated in FIG. 2, the remote controller-side sensor 15 is connected with the remote controller controlling device 14 in the remote controller 12. The remote controller-side sensor 15 detects a discrimination signal from the left direction display device-side transmitter 10L and the right direction display device-side transmitter 10R and provides a detection result to the remote controller controlling device 14.

The remote controller controlling device 14 is connected with the remote controller interface 16 and the remote controller-side transmitter 13. The remote controller interface 16 is operation means such as a power control button, channel buttons, a volume controlling button, and the like provided in the remote controller 12. According to an operation result of the remote controller interface 16 and a detection result from the remote controller-side sensor 15, the remote controller controlling device 14 controls the remote controller-side transmitter 13. The remote controller-side transmitter 13 is controlled by the remote controller controlling device 14 and outputs an operation signal corresponding to a display mode of the TV 1. The operation signal from the remote controller-side transmitter 13 continues to be output for a certain period of time even after a viewer finished the operation.

When the remote controller-side sensor 15 detects the first discrimination signal, the remote controller controlling device 14 controls the remote controller-side transmitter 13 to output a first operation signal corresponding to an operation result of the remote controller interface 16. When the remote controller-side sensor 15 detects the second discrimination signal 1, the remote controller controlling device 14 controls the remote controller-side transmitter 13 to output a second operation signal 1 corresponding to an operation result of the remote controller interface 16. When the remote controller-side sensor 15 detects the second discrimination signal 2, the remote controller controlling device 14 controls the remote controller-side transmitter 13 to output a second operation signal 2 corresponding to an operation result of the remote controller interface 16. The first discrimination signal, the second operation signal 1 and the second operation signal 2 output from the remote controller-side transmitter 13 are signals having at least one different characteristic among characteristics such as amplitude and frequency. Also, each of the first discrimination signal, the second operation signal 1, and the second operation signal 2 is output from an infrared output device in the remote controller-side transmitter 13 as a narrow output range signal with a directional limitation. This allows outputting a certain operation signal to a certain direction. Note that it is not limited to the infrared output device and another transmitter used for wireless communications may be adopted.

In the single view display mode, the TV 1 outputs the first discrimination signal, operation of the remote controller 12 toward the TV 1 allows the volume control and channel selection regardless of a viewer's position. It is possible to output the operation signal only to a display device side-detecting sensor in a desired direction because the remote controller-side transmitter 13 has the directional limitation. When a viewer in the left side watches a left side display of the TV 1 in the multi view display mode, the left side viewer operates the remote controller 12 toward the left side of the TV 1. This allows the channel selection and volume control of the TV 1 because the second operation signal 1 (reference number 20 in FIG. 3) is detected only by the first left direction signal detecting display device-side sensor 8aL. Also, when a viewer in the right side watches a right side display of the TV 1 in the multi view display mode, the right side viewer operates the remote controller 12 toward the right side of the TV 1. This allows the channel selection and volume control of the TV 1 because the second operation signal 2 is detected only by the second right direction signal detecting display device-side sensor 8bR.

Further, when a viewer in the left side watching a left side display of the TV 1 in the multi view display mode selects a channel or controls a volume of the right side display, the left side viewer operates the remote controller 12 toward the right side of the TV 1. This allows the channel selection and volume control of the right side display of the TV 1 because the second operation signal 1 (reference number 21 in FIG. 3) is detected only by the second left direction signal detecting display device-side sensor 8bL. When a viewer in the right side watching a right side display of the TV 1 in the multi view display mode selects a channel or controls a volume of the left side display, the right side viewer operates the remote controller 12 toward the left side of the TV 1. This allows the channel selection and volume control of the left side display of the TV 1 because the second operation signal 2 is detected only by the first right direction signal detecting display device-side sensor 8aR. As explained above, the viewers can control the outputs of the TV 1 in the multi view display mode regardless of the display directions. The remote controller-side transmitter 13 has a narrow output range signal with a directional limitation, and a signal beyond the output limitation suddenly decreases. This allows the remote controller-side transmitter 13 to output various operation signals to a certain direction. Also, the left direction display device-side sensor and the right direction display device-side sensor are arranged in both sides of the TV 1, respectively, or on diagonal lines of the TV 1, respectively. This allows the remote controller 12 to output the operation signal only to a certain direction display device-side sensor. This makes easy to change information provided from the TV 1.

The channel selection and volume control were explained above. It is also possible to shut down only the left side display of the TV 1 in the multi view display mode, or shut down only the right side display of the TV 1 in the multi view display mode by a viewer with use of the remote controller 12. The following is an explanation deals with the case of shutting down only the left side display of the TV 1. When a left side viewer watches the left side display, the left side viewer presses a display OFF button of the remote controller 12 which receives the second discrimination signal 1 so that the second operation signal 1 including a command of shutting down the left side display of the TV 1 is released from the remote controller 12. In the TV 1, the display device controller 5 terminates an operation of a driving IC controlling the left side display or stops supplying an image signal to the left side display according to the detection result of the second operation signal 1. This allows shutting down only the left side display of the TV 1. When activating the left side display of the TV 1 again, a right side viewer should press a display ON button of the remote controller 12 or press a display ON button on the TV 1.

In the case of shutting down the right side display, a right side viewer watching the right side display presses the display OFF button of the remote controller 12 which receives the second discrimination signal 2 so that the second operation signal 2 including a command of shutting down the right side display of the TV 1 is released from the remote controller 12. In the TV 1, the display device controller 5 terminates an operation of a driving IC controlling the right side display or stops supplying an image signal to the right side display according to the detection result of the second operation signal 2. This allows shutting down only the right side display of the TV 1. When activating the right side display of the TV 1 again, a left side viewer should press a display ON button of the remote controller 12 or press a display ON button of the TV 1.

The following explanation deals with an example displaying two different images in the right and left directions as the multi view display mode with referring to FIG. 1 through FIG. 7. The display directions are not limited to the right and left directions and multiple directions are possible.

<Information Display on TV with Use of the Remote Controller 12>

The following explanation deals with information display on the TV 1 with use of the remote controller 12 with referring to FIG. 1, FIG. 2, and FIG. 7. Firstly, when pressing at least one of the power ON buttons (not illustrated) on the TV 1 or in the remote controller 12, the TV 1 operates a display condition detection step of the display device 2 (reference number SO-1 in FIG. 7). The light receiving device 3a and the light receiving device 3b illustrated in FIG. 1 detect light emission and generate a display condition detection signal according to the detection result. The display condition detection signal is provided to the determination device 4.

The determination device 4 determines a display abnormality in the display device 2 based on the display condition detection signal. The determination result is provided to the display device controller 5 as a display condition determination signal from the determination device 4. The display device controller 5 outputs a control signal of the display device 2, which control signals corresponds to the display condition determination signal. The control signal is provided to the display device 2 and display condition information based on the control signal is displayed by the display device 2. The procedure from display condition detection to display of display condition information is carried out in the TV 1 continuously while the TV 1 continues to carry out the information display operation.

When the display device 2 displays the display condition information, the TV 1 outputs at least one of the second discrimination signal 1 and the second discrimination signal 2. The flow proceeds to discrimination signal transmission step (reference number SO-2 in FIG. 7). When the TV 1 is in the multi view display mode, the left direction display device-side transmitter 10L outputs the second discrimination signal 1 and the right direction display device-side transmitter 10R outputs the second discrimination signal 2, alternatively.

When the TV 1 outputs at least one of the second discrimination signal 1 and the second discrimination signal 2, the flow proceeds to TV control step (reference number SO-3 in FIG. 7) and the remote controller 12 is allowed to control the TV 1. First, the remote controller-side sensor 15 in the remote controller 12 illustrated in FIG. 2 detects the second discrimination signal 1 and the second discrimination signal 2. The remote controller-side sensor 15 provides a detection result to the remote controller controlling device 14. The remote controller controlling device 14 determines to output either the second operation signal 1 or the second operation signal 2 from the remote controller-side transmitter 13 according to the detection result. Next, the remote controller controlling device 14 generates a control signal according to the operation result (volume control, channel selection, and the like) of the remote controller interface 16 arranged in the remote controller and the determination result. The generated control signal is provided to the remote controller-side transmitter 13 and the remote controller-side transmitter 13 outputs an operation signal including information for controlling the TV 1.

When the remote controller 12 outputs either the second operation signal 1 or the second operation signal 2, the flow proceeds to TV display step (reference number SO-4 in FIG. 7) and display information control including channel selection and volume control may be conducted in the TV 1. The operation signal from the remote controller 12 is detected by the signal detecting display device-side sensor in the TV 1. The second operation signal is detected by either the first left direction signal detecting display device-side sensor 8aL or the second right direction signal detecting display device-side sensor 8bL. A detection signal from the first left direction signal detecting display device-side sensor 8aL is provided to the channel selection information generator 7a, and a detection signal from the second right direction signal detecting display device-side sensor 8bL is provided to the channel selection information generator 7b. Either the channel selection information generator 7a or the channel selection information generator 7b determines if the second operation signal is detected or not; generates a display control signal corresponding to a display mode in the TV 1 according to the detection result; and provides the display control signal to the display device controller 5. The display device controller 5 selects a specified channel and controls the display device 2 based on the detection result. As a result, the display device 2 displays image of a selected channel.

### <Display of Display Condition Information>

The following explanation deals with display condition detection step (reference number SO-1) with referring to FIG. 6. When the power switch turns ON, the display device 2 starts outputting image data in accordance with recorded display mode and channel information in the TV 1. At the same time, the light receiving device 3a and the light receiving device 3b start detecting light emission and provide a display condition detection signal to the determination device 4 (reference number S9 in FIG. 6).

Next, the determination device 4 determines a display abnormality in the display device 2 based on the display condition detection signal. (reference number S10 in FIG. 6). If the display device 2 never changes displayed image or remains in a black display, the determination device 4 determines as display NG. When the TV 1 in the multi view display mode is determined as display NG, a display condition determination signal corresponding to the determination result shown in No. 4 or No. 5 in Table 1 is provided to the display device controller 5. The display device controller 5 outputs a control signal to display the display condition information that is shown in Table 1 and corresponds to the determination result. The display device 2 receives the control signal and displays the display condition information (reference number S11 in FIG. 6).

In the case where the determination device 4 determines as display OK, a display condition determination signal corresponding to one of the determination results shown in No. 1 through and No. 3 in Table 1 is provided to the display device controller 5. The display device controller 5 outputs a control signal to display the display condition information shown in Table 1 corresponding to the determination result. The display device 2 receives the control signal and displays the display condition information (reference number S11 in FIG. 6).

TABLE 1

| | |
|---|---|
| | Display Condition |
| Determination Result | information |

| | left side | right side | left side | right side |
|---|---|---|---|---|
| | display | display | display | display |
| No. | condition | condition | indication | indication |
| 1 | OK | OK | ← → | ← → |
| 2 | OK | OFF | ← \| | N/A |
| 3 | OFF | OK | N/A | \| → |
| 4 | OK | NG | ← X | N/A |
| 5 | NG | OK | N/A | X → |

| | | |
|---|---|---|
| 6 | OK | ◯ |

←: left side display is active
→: right side display is active
|: left side/right side display is inactive
X: display malfunction
◯: good

In the case where it is determined as display OK in the multi view display mode, an indicator ← → shown in Table 1 is displayed as display condition information on the left side and on the right side of the display device 2. In the case where it is determined as display NG and when the light receiving device 3a detects an abnormality only in the left side display, an indicator X → shown in No. 5 in Table 1 is displayed on the right side of the display device 2. In the case where it is determined as display NG and when the light receiving device 3b detects an abnormality only in the right side display, an indicator ← X shown in No. 4 in Table 1 is displayed on the left side of the display device 2.

In the case where it is determined as display OK in the multi view display mode and when the left side display is not in active, an indicator |→ shown in No. 3 in Table 1 is displayed on the right side of the display device 2. In the case where it is determined as display OK in the multi view display mode and when the right side display is not in active, an indicator ←| shown in No. 2 in Table 1 is displayed on the left side of the display device 2.

When the TV 1 in the single view display mode is determined as display OK, an indicator O shown in No. 6 in Table 1 is displayed in the display device 2. In the case of being determined as display NG and when the light receiving device 3a detects an abnormality only in the left side display, an indicator X→ shown in No. 5 in Table 1 is displayed in the display device 2. In the case of being determined as display NG and when the light receiving device 3b detects an abnormality only in the right side display, an indicator ←X shown in No. 4 in Table 1 is displayed in the display device 2.

After displaying the display condition information, the flow proceeds to continuing detection by light receiving device step (reference number S12 in FIG. 6) or to detection signal transmission step (reference number S0-2 in FIG. 7). In S12, a determination is made either continuing display on the TV 1 or turning OFF the power. When power OFF is not selected by at least one of a power switch on the TV 1 and a power switch in the remote controller 12, the flow goes back to S9 and the light receiving device 3a and the light receiving device 3b detect light emission again. Further, display condition information is displayed according to a new detection result.

When the flow proceeds from a display condition information displaying step (reference number S 11 in FIG. 6) to a discrimination signal transmission step (reference number S0-2 in FIG. 7), the TV 1 outputs at least one of the second discrimination signal 1 and the second discrimination signal 2. The TV 1 includes the multi view display mode in which TV 1 displays two different images in the left display direction and in the right display direction respectively, a single view display mode limited to the left display direction in which the TV 1 displays an image only in the left display direction, and a single view display mode limited to the right display direction in which the TV 1 displays an image only in the right display direction. When the single view display mode limited to the left display direction is selected, only the left direction display device-side transmitter 10L outputs the second determination signal 1 to the left direction. When the single view display mode limited to the right display direction is selected, only the right direction display device-side transmitter 10R outputs the second determination signal 2 to the right direction.

When the multi view display mode is selected in the TV 1, the left direction display device-side transmitter 10L outputs the second determination signal 1 and the right direction display device-side transmitter 10R output the second determination signal 2 alternatively for a certain period. While the left direction display device-side transmitter 10L outputs the second determination signal 1, the right direction display device-side transmitter 10R outputs no signal. While the right direction display device-side transmitter 10R outputs the second determination signal 2, the left direction display device-side transmitter 10L outputs no signal. Accordingly, it is possible to prevent the second determination signal 1 and the second determination signal 2 interfering each other.

<Signal Output from the Remote Controller>

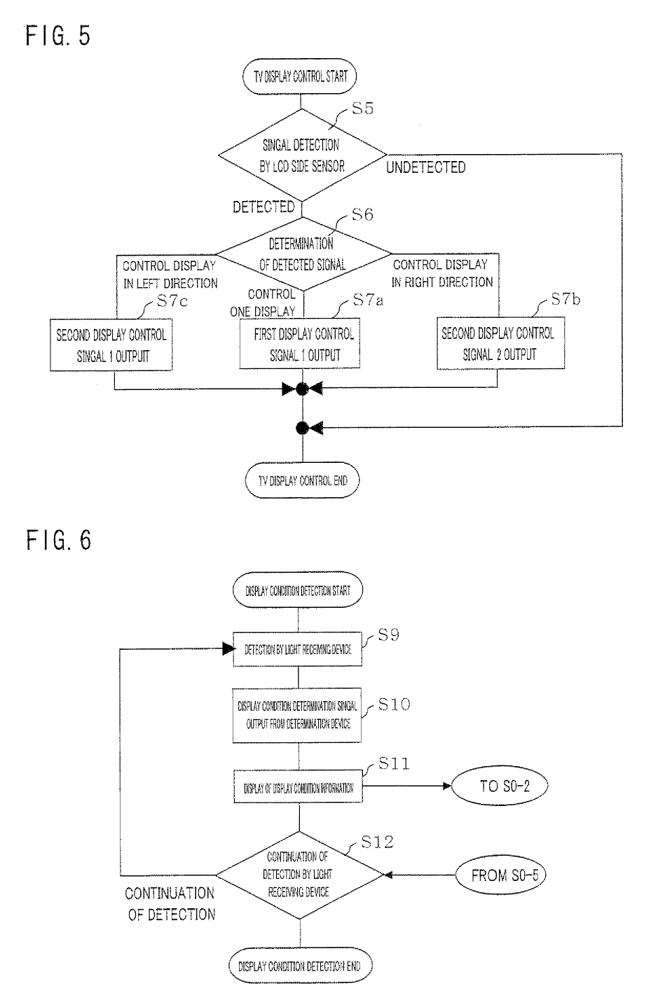

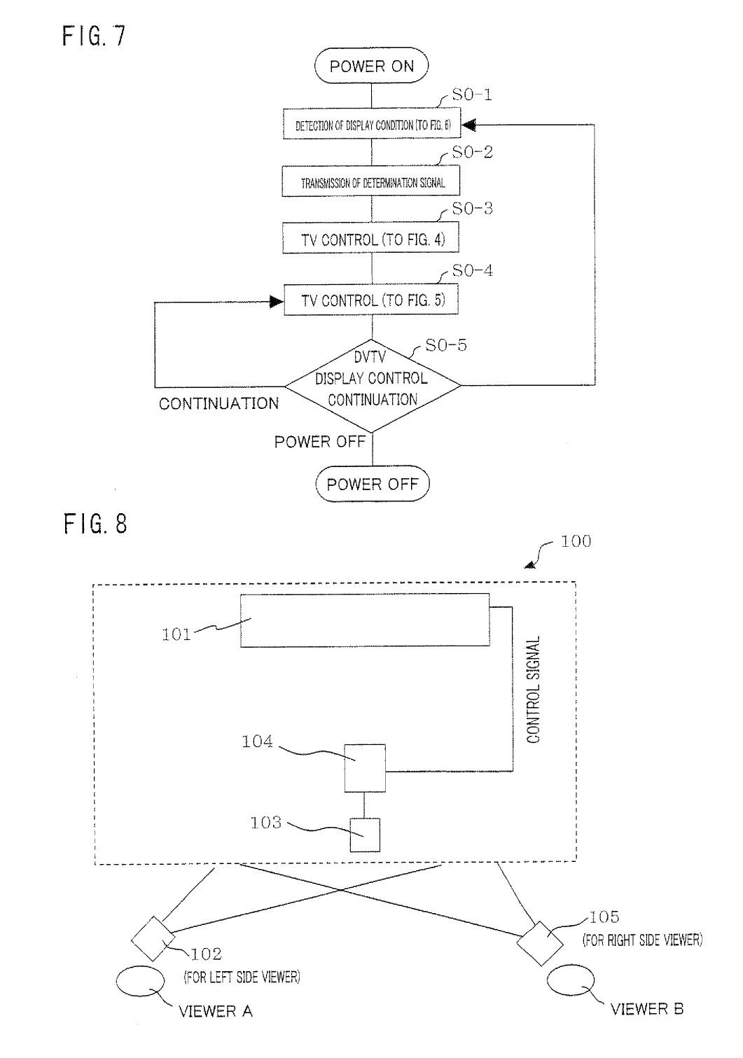

The following explanation deals with a TV 1 control step with use of the remote controller 12 (SO-3) with referring to FIG. 4. Firstly, the remote controller-side sensor 15 in the remote controller 12 detects various discrimination signals from the TV 1 (reference number S1 in FIG. 4). If no discrimination signal is detected, the remote controller-side sensor 15 determines whether power OFF operation is carried out by the remote controller interface 16 or not (reference number S4 in FIG. 4). If power OFF operation is not carried out, the flow goes back from S4 to S1 and the remote controller-side sensor 15 resumes detecting a discrimination signal.

When the remote controller-side sensor 15 detects at least one of the first discrimination signal, the second discrimination signal 1, and the second discrimination signal 2, the detection result is provided from the remote controller-side sensor 15 to the remote controller controlling device 14. The remote controller controlling device 14 determines the remote controller-side transmitter 13 to output any one of the three operation signals, the first operation signal, the second operation signal 1, and the second operation signal 2 (reference number S2 in FIG. 4). Further, the remote controller controlling device 14 provides a control signal to the remote controller-side transmitter 13 for outputting an operation signal including TV 1 controlling information based on the operation result of the remote controller interface 16 operated by a viewer and the determination result in S2 in FIG. 4.

When the remote controller-side sensor 15 detects the first discrimination signal, the remote controller-side transmitter 13 outputs the first operation signal (reference number S3a in FIG. 4). When the remote controller-side sensor 15 detects the second discrimination signal 1, the remote controller-side transmitter 13 outputs the second operation signal 1 (reference number S3c in FIG. 4). When the remote controller-side sensor 15 detects the second discrimination signal 2, the remote controller-side transmitter 13 outputs the second operation signal 2 (reference number S3b in FIG. 4). On releasing an operation signal from the remote controller-side sensor 13, if the power OFF operation is carried out by the remote controller interface 16 or not is detected (reference number S4 in FIG. 4). If the power OFF operation is not carried out, the flow goes back from S4 to S1 and the remote controller-side sensor 15 continues to detect a discrimination signal.

### (Display Control on TV)

The following explanation deals with TV 1 display step (S0-4) with referring to FIG. 5. An operation signal from the remote controller 12 is detected by any one of the signal detecting display device-side sensors provided in the TV 1, the first left direction signal detecting display device-side sensor 8aL, the first right direction signal detecting display device-side sensor 8aR, the second left direction signal detecting display device-side sensor 8bL, and the second right direction signal detecting display side sensor 8bR (reference number S5 in FIG. 5). On releasing the first operation signal from the remote controller 12, at least one of the four sensors in the TV 1 detects the signal. The detection result is provided to either the channel selection information generator 7a or the channel selection information generator 7b.

On releasing the second operation signal 1 from the remote controller 12, either the first left direction signal detecting display device-side sensor 8aL or the second left direction signal detecting display device-side sensor 8bL detects the signal. The detection result is provided to either the channel selection information generator 7a or the channel selection information generator 7b. Further, on releasing the second operation signal 2 from the remote controller 12, either the first right direction signal detecting display device-side sensor 8aR or the second right direction signal detecting display side sensor 8bR detects the signal. The detection result is provided to either the channel selection information generator 7a or the channel selection information generator 7b.

In the case where no operation signal is detected, the flow proceeds from S5 to a DVTV display control continuation step (reference number S8 in FIG. 5), and the determination whether continuing the display control of the TV 1 or shutting down the power is made in the DVTV display control continuation step S0-5 in FIG. 7. When the power switch is ON, the flow goes back to S5 in FIG. 5 for continuing the display control and the TV 1 detects an operation signal from the remote controller 12.

A detection result released from the first left direction signal detecting display device-side sensor 8aL or the first right direction signal detecting display device-side sensor 8aR is provided to the channel selection information generator 7a for a determination of the detection result (reference number S6 in FIG. 5). Also, a detection signal released from the second left direction signal detecting display device-side sensor 8bL or the second right direction signal detecting display device-side sensor 8bR is provided to the channel selection information generator 7b for a determination of the detection result (reference number S6 in FIG. 5).

According to the determination result, the channel selection information generator 7a or the channel selection information generator 7b generates a display control signal corresponding to a display mode. The generated display control signal is provided to the display device controller 5. When the display control signal is for a channel selection, the display device controller 5 selects a desired channel information and provides a control signal to the display device 2 to make the display device 2 display the selected channel information (reference number S7a to S7c in FIG. 5).

On detecting the first operation signal, the first display control signal is generated by the channel selection information generator 7a or the channel selection information generator 7b, and is provided to the display device controller 5. When the first display control signal demands a channel change, the display device controller 5 selects the specified channel information as data to display. Further, the display device controller 5 controls the display device 2 with the control signal for displaying the selected channel information (reference number S7a in FIG. 5).

When the second operation signal 1 is detected by the first left direction signal detecting display device-side sensor 8aL, the channel selection information generator 7a generates the second display control signal 1 for changing information displayed in the left direction of the display device 2 and provides the signal to the display device controller 5. Further, when the second operation signal 1 is detected by the second left direction signal detecting display device-side sensor 8bL, the channel selection information generator 7b generates the second display control signal 2 for changing information displayed in the right direction of the display device 2 and provides the signal to the display device controller 5 (reference number S7c in FIG. 5).

When the second display control signal 1 or the second display control signal 2 demands a channel change, the display device 5 selects the specified channel information as data to display. Further, the display device controller 5 controls the display device 2 with the control signal for displaying the selected channel information in the left display direction.

Further, when the second operation signal 2 is detected by the first right direction signal detecting display device-side sensor 8aR, the channel selection information generator 7a generates the second display control signal 1 for changing information displayed on the display device 2 in the left display direction and provides the signal to the display device controller 5. When the second operation signal 2 is detected by the second right direction signal detecting display device-side sensor 8bR, the channel selection information generator 7b generates the second display control signal 2 for changing information displayed on the display device 2 in the right display direction and provides the signal to the display device controller 5 (reference number S7b in FIG. 5).

On detecting the second control signal 1, the display device controller 5 controls the discrimination signal generator 9 so as not to output the second discrimination signal 1 and the second discrimination signal 2. The remote controller-side transmitter 13 continues to output the second operation signal 1 for a certain period of time even after a viewer finished the operation. This allows the first left direction signal detecting display device-side sensor 8aL or the second left direction signal detecting display device-side sensor 8bL to detect the second operation signal 1 without interference with the discrimination signal. When the channel selection information generator 7a or the channel selection information generator 7b determines the detection of the second operation signal 1, the detection result is provided to the display device controller 5 from the channel selection information generator 7a or 7b. The display device controller 5 selects a specified channel image and controls the display device 2. As a result, the channel image specified by the display device 2 is displayed. When the display device 2 displays the specified channel image, the display device controller 5 controls the discrimination signal generator 9 so as to resume outputting the second discrimination signal 1 and the second discrimination signal 2.

Likewise, on detecting the second control signal 2, the display device controller 5 controls the discrimination signal generator 9 so as not to output the second discrimination signal 1 and the second discrimination signal 2. The remote controller-side transmitter 13 continues to output the second operation signal 2 for a certain period of time even after a viewer finished the operation. This allows the first left direction signal detecting display device-side sensor 8aL or the second left direction signal detecting display device-side sensor 8bL to detect the second operation signal 2 without interference with the discrimination signal. When the channel selection information generator 7a or the channel selection information generator 7b determines the detection of the second operation signal 2, the detection result is provided to the display device controller 5 from the channel selection information generator 7a or 7b. The display device controller 5 selects a specified channel image and controls the display device 2. As a result, the channel image specified by the display device 2 is displayed. When the display device 2 displays the specified channel image, the display device controller 5 controls the discrimination signal generator 9 so as to resume outputting the second discrimination signal 1 and the second discrimination signal 2.

In completing the control of the TV 1 according to the operation signal from the remote controller 12, the flow proceeds to DVTV display control continuation step (reference number S0-5 in FIG. 7) and a determination is made either continuing the display on the TV 1 or turning off the power. In the case of continuing the display control, the flow goes back to the display step S0-4, reference number S5 in FIG. 5, and an operation signal from the remote controller 12 is detected.

When the power OFF is selected in the DVTV display control continuation step S0-5, the flow also proceeds to S12 in FIG. 6 and the display condition detection and display of display condition information are terminated in the TV 1. Also, a display on the TV 1 is shut down due to the selection of the power OFF.

Each of the processing steps of the display system is carried out in such a manner that unillustrated operation means such as a CPU carries out a program stored in recording means such as a ROM, and a RAM and controls output means such as a LCD interface 11 illustrated in FIG. 1, and display device 2. Therefore, a microcomputer including those means is able to carry out each of the functions and processes of an instrument panel display system of the present embodiment by retrieving the program stored in the recording media 6 and carrying out the program. Also, it is possible to carry out each of the functions and processes in any computers by means of storing the program in a removable recording media.

As the recording media, unillustrated memories processed by a microcomputer such as a ROM may be used as a program media. Alternatively, the program media may be provided as an unillustrated external recording media which can be retrievable by means of inserting a recording media.

In any cases, it is preferable that the stored program is carried out by an access of a microprocessor. Further, it is preferable that after retrieving the program, the retrieved program was downloaded into a program storage area in the microcomputer to be carried out. Note that the program for downloading is stored inside a main body of the microcomputer in advance.

The program media is a recording media which is separable to the main body including tapes such as a magnetic tape, a cassette tape, and the like; magnetic discs such as a CD, an MO, an MD, a DVD, and the like; cards such as an IC card, a memory card, and the like; a mask ROM, a EPROM (ErasabLe ProgrammabLe Read OnLy Memory), a EEPROM (ElectricaLLy ErasabLe ProgrammabLe Read OnLy Memory); a semi-conductor memories such as a flush ROM for having the program statically.

It is preferable that a recording media has the program flexibly such as downloading the program from a communication network in a system structure which is connectable to communication networks including internet.

Further, in the case of downloading the program via a communication network, it is preferable that the program for downloading is stored inside the main body in advance or is installed from another recording media.

Note that the present invention is not limited to the above embodiment. Wide variety of alteration is available within the range defined in claims. Namely, any embodiments that will be obtained by combining the technical means, which are altered within the range defined in claims as needed, should also be included in the technical scope of the present invention.

For example, a display device, a display system, a display method, a program, and a memory media may be arranged as follows.

Namely, a display system of the present invention includes a display device including display means which is capable of displaying different information in different display directions, and an operation device configured to transmit operation signals having different characteristics to the different display directions of the display means. The display system may have such a structure that the display device includes: display device-side transmission means configured to transmit discrimination signals having different characteristics to the different display directions, display device-side detection means configured to detect the operation signal, display control signal generation means configured to generate display control signals for controlling the display means according to a detection result of the display device-side detection means, and display control means configured to control the display means according to the display control signal; the operation device includes: operation device-side detection means for detecting the discrimination signals released from the display device, and operation device-side transmission means configured to transmit the operation signals according to the discrimination signal detected by the operation device-side detection means.

This structure allows the operation means to release operation signals having different characteristics to the different display directions. Therefore, it is possible for viewers to control display information regardless of their viewing directions.

Further, in this display system, it is preferable that the operation device-side transmission means in the operation device transmits an operation signal with a directional limitation.

This structure allows a viewer to control information displayed on the display device by operating the operation device toward a desired display direction.

Further, in this display system, it is preferable that the display device further includes display condition detection means for detecting a display condition of the display means, the display control means of the display device controls the display means to display information indicating the display condition of the display means based on the detection result of the display condition detection means.

This structure allows a viewer to deal with a display abnormality based on information of the display abnormality displayed on the display means.

Further, in this display system, it is preferable that the display device includes the plurality of display side detection means corresponding to the display directions of the display means, each of the display side detection means is arranged in an edge part of the display device corresponding to the display direction of each display side detection means.

With this structure, a display side detection means in a first direction where information is displayed is arranged in an edge part of the display device at the end of the first display direction. Accordingly, it is possible to be arranged having a distance with another display side detection means arranged in another display direction. As a result, a viewer can specify an output direction of the operation signal generated by the operation device.

Further, it is preferable that the display side detection means is arranged in an edge part which is an opposing corner of the display means.

With this structure, each of the display side detection means is arranged on a diagonal line of the display device. Accordingly, it is possible that each of the display side detection means is arranged leaving a distance one another. As a result, a viewer can specify an output direction of the operation signal generated by the operation device.

Note that this invention is not limited to the display system and the display program, the display method, and the computer retrievable recording media storing the program which are used in the display system are all included.

With this structure, when the multi view display mode is operated by the display means, it is possible for a viewer to control output information regardless of a viewing direction because a discrimination signal is released corresponding to each of the display directions of the display means and the operation device outputs an operation signal corresponding to the display direction.

As described above, in this display system, operation means outputs a plurality of different operation signal depending on each of the display directions and the display operation of the display means is controlled based on the operation signal. This allows a viewer to control a plurality of information output from the display means regardless of the viewer's position.

### INDUSTRIAL APPLICABILITY

The display system of the present invention is widely applicable as an information display system for displaying information such as a static image and a movie.

1. A display device comprising:
display means which is capable of displaying information in different display directions;
a plurality of operation signal receiving means provided respectively corresponding to the different display directions, and each configured to receive an operation signal; and
display control means configured to control the display means to display information according to the operation signal in the direction corresponding to that one of the operation signal receiving means which received the operation signal.

2. The display device as set forth in claim 1, wherein:
the operation signal receiving means are respectively provided in an edge part of the display device in such a manner that the operation signal receiving means is provided at that portion of the edge part which is on the display direction that the operation signal receiving means corresponds.

3. The display device as set forth in claim 2, wherein:
the operation signal receiving means is arranged on a line overlapping a diagonal line of the display means.

4. The display device as set forth in claim 1, further comprising:
discrimination signal transmission means configured to transmit discrimination signals having different characteristics to the different display directions,
wherein the operation signal receiving means receives an operation signal, (i) which is transmitted from the operation device which received the discrimination signal, and (ii) which corresponds to the direction where the operation device is located.

5. The display device as set forth in claim 1, further comprising:
display condition detection means configured to detect a display condition of the display means,
wherein the display control means is configured to display information indicating the display condition of the display means according to a detection result of the display condition detection means.

6. A display system comprising a display device and an operation device configured to transmit an operation signal to the display device, wherein:
the display device includes:
display means which is capable of displaying information in a plurality of different display directions;
a plurality of operation signal receiving means configured to receive an operation signal which are provided corresponding to the plurality of different display directions; and
display control means which controls the display means to display information according to the operation signal in a direction corresponding to any one of the operation signal receiving means which received the operation signal,
the operation device includes:
operation signal transmission means configured to transmit the operation signal on a directional carrier wave to any one of the operation signal receiving means.

7. A method of displaying information on a display device which is capable of displaying information in different display directions, comprising:
providing the display device comprising operation signal receiving means respectively corresponding to the different display directions;
receiving an operation signal by any one of the operation signal receiving means; and
displaying information according to the operation signal in the display direction corresponding to that one of the operation signal receiving means which received the operation signal.

8. (canceled)

9. (canceled)

10. A computer-readable recording medium which stores a program causing a computer to operate as each of means included in a display device as set forth in claim 1.

11. A computer-readable recoding medium which stores a program causing a computer to operate as each of means included in a display device as set forth in claim 5.
